(19) United States
(12) Patent Application Publication
(10) Pub. No.: US 2016/0014346 A1
(43) Pub. Date: Jan. 14, 2016

(54) IMAGE PROCESSING SYSTEM, IMAGE PROCESSING DEVICE, AND IMAGE PROCESSING METHOD

(71) Applicant: PANASONIC INTELLECTUAL PROPERTY MANAGEMENT CO., LTD., Osaka (JP)

(72) Inventors: Masaaki KOBAYASHI, Fukuoka (JP); Masakatsu MATSUO, Fukuoka (JP); Kouji MUTOU, Fukuoka (JP); Katsunori KOGATA, Saitama (JP)

(73) Assignee: PANASONIC INTELLECTUAL PROPERTY MANAGEMENT CO., LTD., Osaka (JP)

(21) Appl. No.: 14/793,064

(22) Filed: Jul. 7, 2015

(30) Foreign Application Priority Data
Jul. 14, 2014 (JP) 2014-144361

(51) Int. Cl. H04N 5/262; H04N 1/00; H04N 7/18

(52) U.S. Cl. CPC H04N 5/262; H04N 7/181; H04N 1/00209

(57) ABSTRACT

A first image processing device of an image processing system performs a blurring process on captured first image data, obtains second image data, performs a distribution process on the first image data or third image data based on the first image data, obtains a plurality of shares, and transmits the second image data and the plurality of shares to at least one designated storage device. A second image processing device of the image processing system receives the second image data and the plurality of shares from the at least one designated storage device, and restores the first image data based on at least the plurality of shares.

### BACKGROUND OF THE INVENTION

1. Field of the Invention

The present invention relates to an image processing system, an image processing device, and an image processing method.

2. Description of the Related Art

In a monitoring camera system described in Japanese Patent Unexamined Publication No. 2008-288744, privacy is protected by hiding a partial region of a captured image with a mask in normal circumstances, and security is ensured by restoring the part hidden with the mask in emergency circumstances (for example, at the time of the occurrence of a crime).

### SUMMARY OF THE INVENTION

The present invention provides an image processing system, an image processing device, and an image processing method that are capable of achieving both privacy and security, allowing the outline of image data to be easily checked, and improving the degrees of freedom of the save destination of the image data.

An image processing system of the present invention is an image processing system in which a first image processing device, a second image processing device, and storage devices are connected via the Internet, in which the first image processing device includes an image generating unit that performs a blurring process on captured first image data, and obtains second image data; a distribution processing unit that performs a distribution process on the first image data or third image data based on the first image data, and obtains a plurality of shares; and a first communication unit that transmits the second image data and the plurality of shares to at least one designated storage device, in which the storage device stores at least one of the shares and the second image data from the first image processing device, and in which the second image processing device includes a second communication unit that receives the second image data and the plurality of shares from the at least one designated storage device, and a restoration processing unit that restores the first image data based on at least the plurality of shares.

An image processing device includes an image generating unit that performs a blurring process on captured first image data, and obtains second image data; a distribution processing unit that performs a distribution process on the first image data or third image data based on the first image data, and obtains a plurality of shares; and a communication unit that transmits the second image data and the plurality of shares to at least one designated storage device.

An image processing device includes a communication unit that receives second image data obtained by performing a blurring process on captured first image data from at least one designated storage device, and a plurality of shares, and a restoration processing unit that restores the first image data based on at least the plurality of shares in which the shares are obtained by performing a distribution process on the first image data or third image data based on the first image data.

An image processing method in an image processing system in which a first image processing device, a second image processing device, and storage devices are connected via the internet, the method includes causing the first image processing device to perform a blurring process on captured first image data, and to obtain second image data; causing the first image processing device to perform a distribution process on the first image data or third image data based on the first image data, and to obtain a plurality of shares; causing the first image processing device to transmit the second image data and the plurality of shares to at least one designated storage device; causing the second image processing device to receive the second image data and the plurality of shares from the at least one designated storage device; and causing the second image processing device to restore the first image data based on at least the plurality of shares.

According to the present invention, it is possible to achieve both privacy and security, to allow the outline of image data to be easily checked, and to improve the degrees of freedom of the save destination of the image data.

### BRIEF DESCRIPTION OF DRAWINGS

FIG. 1 is a schematic diagram showing a configuration example of a camera system according to a first embodiment;

FIG. 2 is a block diagram showing a configuration example of a camera according to the first embodiment;

FIG. 3 is a schematic diagram showing an example of the format of shares according to the first embodiment;

FIG. 4 is a block diagram showing a configuration example of an image distributing unit according to the first embodiment;

FIG. 5 is a block diagram showing a configuration example of a personal computer (PC) according to the first embodiment;

FIG. 6 is a block diagram showing a configuration example of an image restoring unit according to the first embodiment;

FIG. 7A is a schematic diagram for schematically describing an example of secret sharing scheme according to the first embodiment;

FIG. 7B is a schematic diagram for schematically describing the outline of an example of secret sharing scheme according to the first embodiment;

FIG. 8 is a flowchart showing an example of an initial setting procedure performed by a predetermined terminal according to the first embodiment;

FIG. 9 is a schematic diagram showing an example of the registration content of a configuration file according to the first embodiment;

FIG. 10 is a flowchart showing an example of a processing procedure performed by the camera according to the first embodiment;

FIG. 11 is a flowchart showing an example of a processing procedure performed by the PC according to the first embodiment;

FIG. 12 is a block diagram showing a configuration example of a camera according to a second embodiment;

FIG. 13 is a schematic diagram showing an example of the format of shares according to the second embodiment;

FIG. 14 is a block diagram showing a configuration example of an image distributing unit according to the second embodiment;

FIG. 15 is a schematic diagram showing a configuration example of a PC according to the second embodiment;

FIG. 16 is a block diagram showing a configuration example of an image restoring unit according to the second embodiment;

FIG. 17 is a block diagram showing a configuration example of a camera according to a third embodiment;

FIG. 18A is a schematic diagram showing an example of the format of shares when a blurred image is combined with one share of a differential image according to the third embodiment;

FIG. 18B is a schematic diagram showing an example of the format of shares when a blurred image is combined with all shares of a differential image according to the third embodiment;

FIG. 19 is a block diagram showing a configuration example of a PC according to the third embodiment;

FIG. 20 is a flowchart showing an example of a processing procedure of a camera according to the third embodiment;

FIG. 21 is a flowchart showing an example of a processing procedure of the PC according to the third embodiment;

FIG. 22 is a block diagram showing a configuration example of a camera according to a fourth embodiment;

FIG. 23A is a schematic diagram showing an example of the format of shares when a blurred image is combined with one share of an original image according to the fourth embodiment;

FIG. 23B is a schematic diagram showing an example of the format of shares when a blurred image is combined with all shares of an original image according to the fourth embodiment;

FIG. 24 is a block diagram showing a configuration example of a PC according to the fourth embodiment;

FIG. 25 is a schematic diagram showing the configuration of a camera system according to Modification Example 1;

FIG. 26 is a schematic diagram showing the configuration of a camera system according to Modification Example 2;

FIG. 27 is a schematic diagram showing the configuration of a camera system according to Modification Example 3;

FIG. 28 is a schematic diagram showing the configuration of a camera system according to Modification Example 4;

FIG. 29 is a schematic diagram showing the configuration of a camera system according to Modification Example 5;

FIG. 30 is a schematic diagram showing the configuration of a camera system according to Modification Example 6;

FIG. 31 is a schematic diagram showing the configuration of a camera system according to Modification Example 7; and

FIG. 32 is a block diagram showing configuration examples of a camera and a PC according to Modification Example 7.

### DETAILED DESCRIPTION OF THE PREFERRED EMBODIMENTS

Hereinafter, embodiments of the present invention will be described with reference to the drawings.

### Background of Embodiment of the Present Invention

For example, in the monitoring camera system described in Japanese Patent Unexamined Publication No. 2008-288744, it is difficult to check the content of a masked region (mask region). For example, when content having low relevance to privacy (for example, whether or not there is a person in a store) is included in the mask region, if the mask region is not restored, it is difficult to check the content.

For example, when a mask is formed on an image due to noise superposition, the image on which the mask has not been formed is not restored in some cases.

In a base (for example, a store or a bank) where a monitoring camera is provided, there are places where it is difficult to provide a recorder that stores an image captured by the monitoring camera. In this case, image data being saved through, for example, cloud computing may be considered. However, when cloud computing is simply used, there is a concern that the content of the image data may be decoded if the image data is stolen. That is, when it is attempted to safely manage the image data, the storing place of the image data is restricted in some cases. The image data is preferably saved in a place including a storage device on a cloud based on various management policies.

Hereinafter, an image processing system, an image processing device, and an image processing method that are capable of achieving both privacy and security, allowing the outline of image data to be easily checked, and improving the degrees of freedom of the save destination of the image data will be described.

An image processing system according to the following embodiments is applied to a camera system that stores images captured by a camera.

### First Embodiment

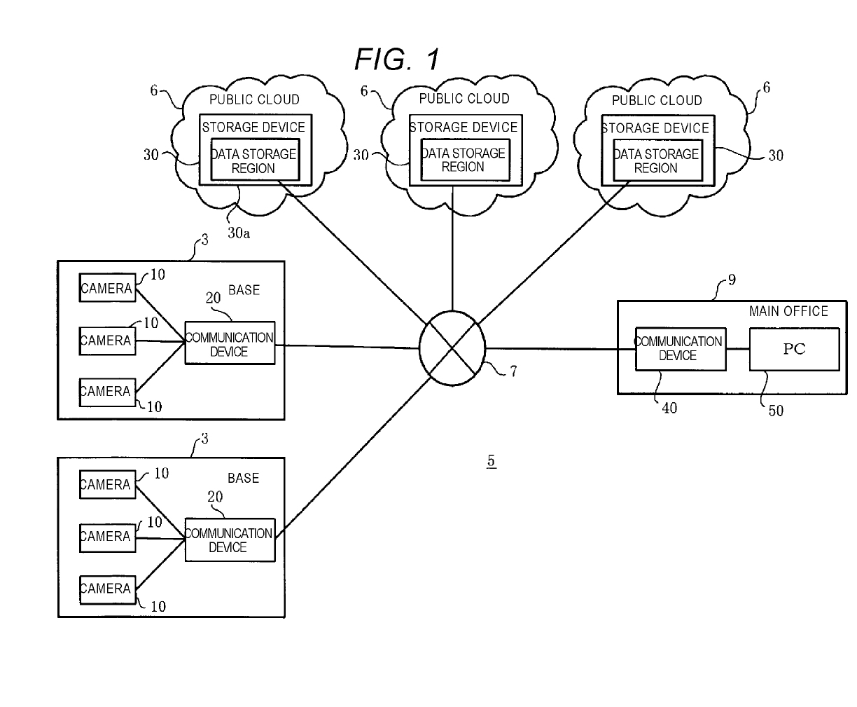

FIG. 1 is a schematic diagram showing a configuration example of camera system 5 according to a first embodiment. For example, in camera system 5, cameras 10, storage devices 30, and personal computer (PC) 50 are connected via Internet 7.

Cameras 10 (an example of a capturing device) are respectively provided in, for example, multiple bases 3, and are connected to communication devices 20. Multiple cameras 10 may be provided in each base 3. Storage devices 30 are respectively arranged in, for example, multiple public clouds 6. Multiple storage devices 30 may be provided in each public cloud 6. PC 50 is provided in main office 9, and is connected to communication device 40. Camera 10 and communication device 20 are an example of a first image processing device. PC 50 is an example of a second image processing device.

Base 3 (an example of an area) includes, for example, various stores (for example, a convenience store and a bank). For example, multiple cameras 10 that monitor the inside of base 3 are provided in each base 3 in order to prevent crimes.

A distribution process is performed on image data (original image) (an example of first image data) captured by each camera 10 based on the captured image data, and shares are generated. The shares generated by each camera 10 are transmitted to Internet 7 through communication device 20.

For example, communication device 20 includes at least one of a router and a modem that are capable of being connected to Internet 7, and transmits the image data output from camera 10 to Internet 7. The router and the modem may be realized as hardware, or may be functionally realized as software.

Public cloud 6 is operated through cloud computing. For example, various data items can be saved in storage device 30 on public cloud 6 connected to a public communication network (for example, Internet 7). Storage device 30 includes, for example, a hard disk drive (HDD), and a solid state drive (SSD). The public communication network includes at least one of a public wireless network and a public wired network.

Main office 9 (an example of an area) is, for example, a monitoring center that monitors the images captured by each camera 10. PC 50 is provided in main office 9. In place of PC 50, a tablet terminal may be provided. For example, PC 50 performs a restoration process based on the shares received from Internet 7 through communication device 40, and generates the original image. Similarly to communication device 20, communication device 40 includes at least one of a router and a modem.

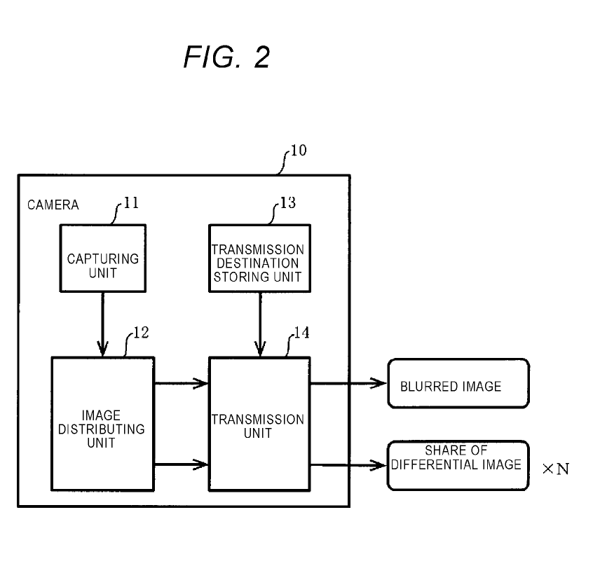

FIG. 2 is a block diagram showing a configuration example of camera 10. Here, a case where a differential image, to be described below, is distributed is illustrated. Camera 10 includes capturing unit 11, image distributing unit 12, transmission destination storing unit 13, and transmission unit 14.

For example, capturing unit 11 generates an electrical signal by forming an image using light concentrated through a lens on an image sensor, and obtains the original image (frame image).

Image distributing unit 12 performs a predetermined blurring process on the original image obtained by capturing unit 11, and generates a blurred image (an example of second image data). Accordingly, image distributing unit 12 has a function of an image generating unit. Image distributing unit 12 may perform the blurring process on a specific region (for example, region including the face of a person) in the original image. Thus, the legibility of the specific region is decreased, and thus, it is possible to protect privacy.

Image distributing unit 12 generates a differential image (an example of third image data) representing a difference between the original image and the blurred image. For example, image distributing unit 12 obtains the differential image by subtracting the values of pixels corresponding to the original image and the blurred image. For example, image distributing unit 12 may generate a differential image of the same region so as to correspond to the specific region on which the blurring process has been performed. Thus, it is possible to reduce a process load for generating the differential image.

Image distributing unit 12 performs a distribution process related to a predetermined secret sharing scheme method (secret sharing scheme process) on the differential image, and generates a plurality of shares of the differential image. That is, a plurality of shares is generated for one differential image.

Accordingly, image distributing unit 12 has a function of a distribution processing unit. The secret sharing scheme process will be described in detail below.

For example, image distributing unit 12 may generate a low-frequency image, to be described below, from the original image in the blurring process, or may generate the blurred image by performing various filtering processes on the original image. For example, image distributing unit 12 may generate the blurred image by superposing noise on the original image in the blurring process, or may generate the blurred image by periodically replacing a pixel region with a blank or another image every predetermined pixel. That is, image distributing unit 12 can understand the outline of the original image, and performs the blurring process such that the detail of the original image is unclear.

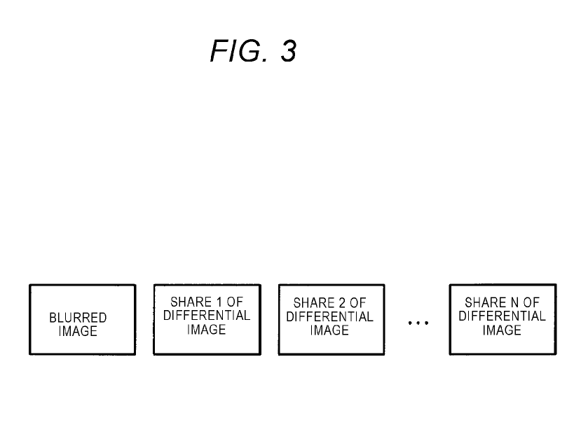

FIG. 3 is a schematic diagram showing an example of the format of shares.

The blurred image and the plurality (N number) of shares of the differential image are generated from the image data captured by camera 10. In this case, the original image is restored by combining the blurred image and the plurality of shares of the differential image.

For example, a low-frequency image that is generated by dividing the image according to each of predetermined regions and calculating an average of pixels within the predetermined region is used as the blurred image. The low-frequency image is an image from which low-frequency components are extracted, and an image (for example, an image obtained by blurring a focus, and an image to which a mosaic is applied) that is difficult to check the detail thereof without including a detailed part of the image such as a contour expressed by components having a high spatial frequency.

Accordingly, it is possible to grasp the rough situation (outline) of a place or a subject captured by camera 10 by using the low-frequency image. However, since it is difficult to check the detail of the place or the subject, it is possible to protect privacy.

Transmission destination storing unit 13 stores at least one transmission destination to which the blurred image and the plurality of shares are transmitted. For example, storage devices 30 that are respectively present in three public clouds 6 are registered as the transmission destinations. Transmission destination storing unit 13 may store configuration file 75 (see FIG. 9), to be described below. The “transmission destination” of the image or the data mentioned herein is also referred to as a “save destination” of the image or the data.

Data storage region 30a is allocated to storage device 30. For example, an internet protocol (IP) address, a media access control (MAC) address, or information related to a folder path are used to designate the transmission destination. The transmission destination stored in transmission destination storing unit 13 is registered in configuration file 75.

Transmission unit 14 transmits the blurred image and the plurality (N number) of shares of the differential image generated by image distributing unit 12. For example, transmission unit 14 transmits the blurred image and the shares to the transmission destination registered in configuration file 75. Transmission unit 14 may directly transmit the blurred image to PC 50. Thus, a user of PC 50 can check the blurred image in real time. Transmission unit 14 is an example of a first communication unit.

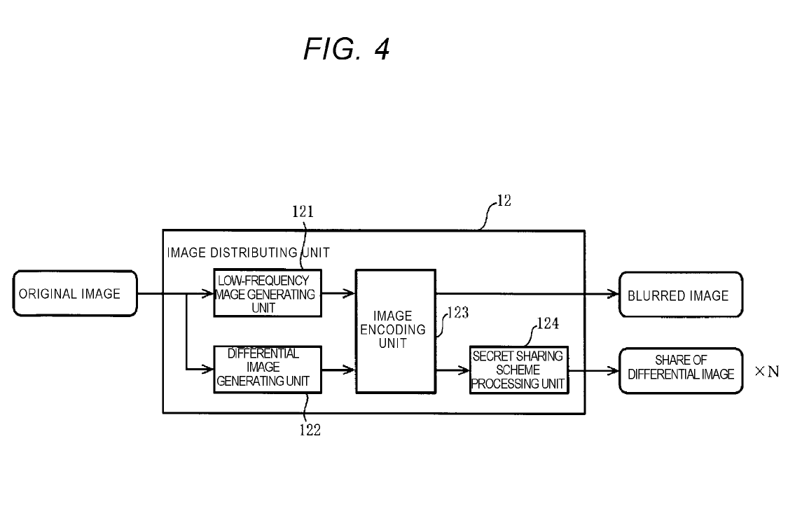

FIG. 4 is a block diagram showing a configuration example of image distributing unit 12. In FIG. 4, a case where the differential image is distributed is illustrated. Image distributing unit 12 includes low-frequency image generating unit 121, differential image generating unit 122, image encoding unit 123, and secret sharing scheme processing unit 124.

Low-frequency image generating unit 121 generates the low-frequency image from the original image. For example, low-frequency image generating unit 121 generates the low-frequency image by converting the image into a spatial frequency domain and extracting components having a low spatial frequency. For example, low-frequency image generating unit 121 generates the low-frequency image by performing a predetermined frequency transform (for example, Fourier transform, discrete cosine transform, or wavelet transform) on the frame image and performing reverse transform that extracts components having a low spatial frequency. The low-frequency image is an example of the blurred image.

Differential image generating unit 122 generates the differential image between the original image obtained by camera 10 and the low-frequency image generated by low-frequency image generating unit 121.

Image encoding unit 123 encodes the low-frequency image and the differential image.

Secret sharing scheme processing unit 124 performs the distribution process on the encoded differential image, and obtains the plurality (N number) of shares.

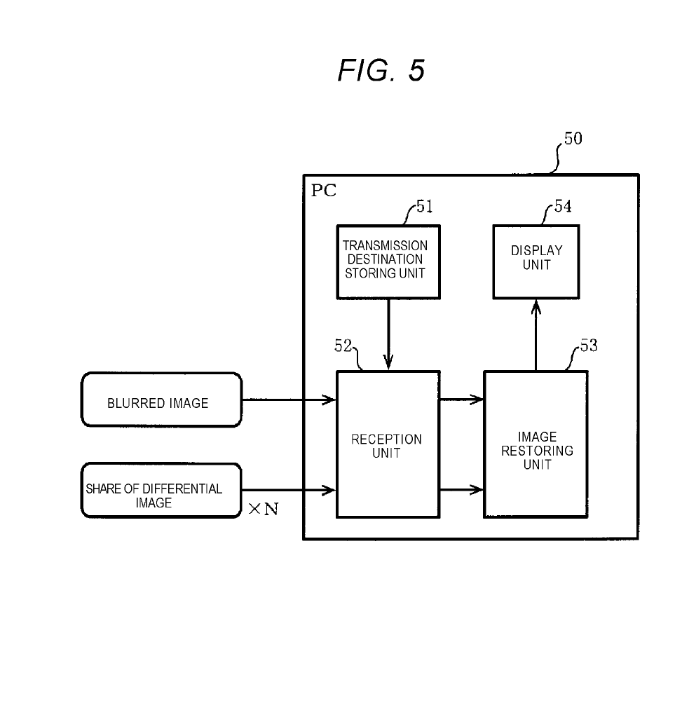

FIG. 5 is a schematic diagram showing a configuration example of PC 50. PC 50 includes transmission destination storing unit 51, reception unit 52, image restoring unit 53, and display unit 54.

For example, transmission destination storing unit 51 stores the transmission destination in which the blurred image and the shares of the differential image are stored. The transmission destination is registered in configuration file 75. Transmission destination storing unit 51 may store configuration file 75.

For example, reception unit 52 receives the blurred image and the plurality of shares of the differential image via Internet 7 by referring to the transmission destination. For example, reception unit 52 receives the differential image corresponding to the encoded low-frequency image to be restored. Reception unit 52 is an example of a second communication unit.

Image restoring unit 53 performs a restoration process related to a predetermined secret sharing scheme method (secret sharing scheme process) using the blurred image and the plurality of shares of the differential image, and obtains the original image. Accordingly, image restoring unit 53 has a function of a restoration processing unit.

Display unit 54 reproduces the original image restored by image restoring unit 53, and displays the reproduced image.

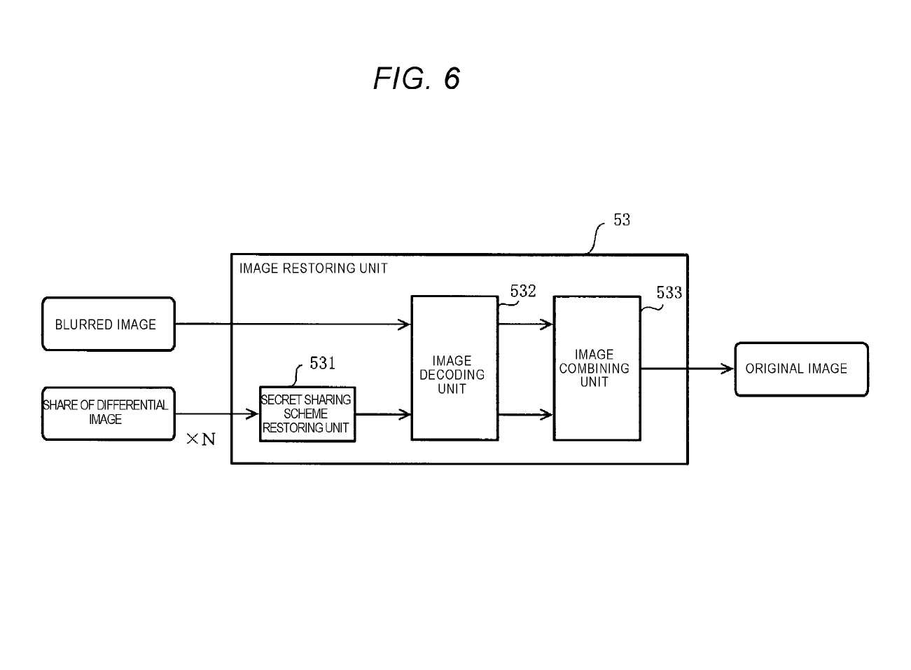

FIG. 6 is a block diagram showing a configuration example of image restoring unit 53. Image restoring unit 53 includes secret sharing scheme restoring unit 531, image decoding unit 532, and image combining unit 533.

Secret sharing scheme restoring unit 531 obtains the plurality of shares of the differential image, performs the restoration process on the shares, and restores the encoded data of the differential image.

Image decoding unit 532 decodes the encoded data of the differential image and the encoded data of the blurred image, and generates data related to the blurred image corresponding to one frame and data related to the differential image corresponding to one frame.

The blurred image and the differential image are data items encoded by image encoding unit 123 of camera 10. For example, when the data is encoded in a standard compression format, image restoring unit 53 decodes the encoded data in a standard decoding format. When the data is encoded by a unique encoding scheme, image restoring unit 53 decodes the encoded data by the corresponding unique decoding scheme.

Image combining unit 533 combines the decoded blurred image with the decoded differential image, and restores the original image. For example, image combining unit 533 obtains the original image by adding the values of pixels corresponding to the differential image and the blurred image.

Next, specific examples of the secret sharing scheme process will be described.

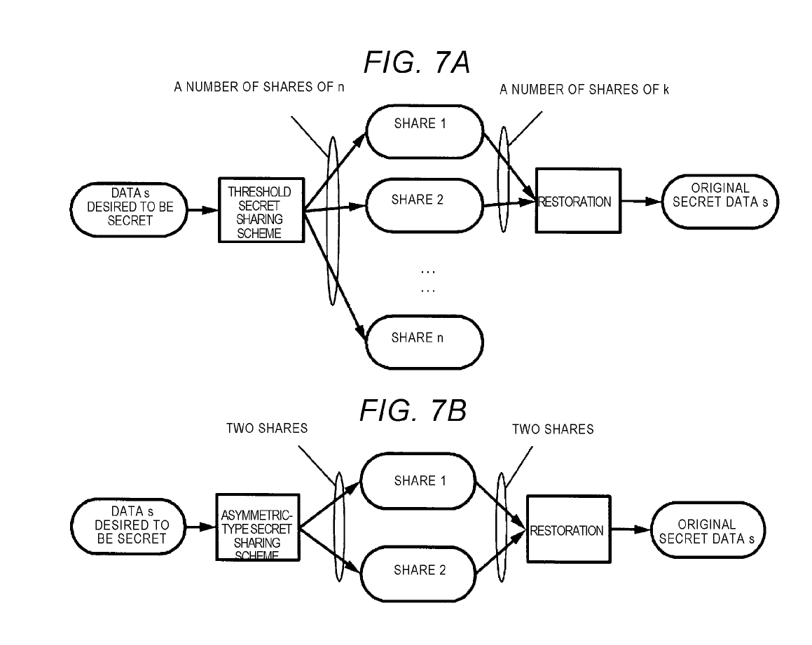

FIG. 7A and FIG. 7B are schematic diagrams for schematically describing examples of the secret sharing scheme process. FIG. 7A shows a symmetric-type secret sharing scheme process. The symmetric-type secret sharing scheme process includes, for example, a threshold secret sharing scheme process, and a ramp secret sharing scheme process.

The symmetric-type means that size ratios (distribution ratios) between the respective shares generated by performing the distribution process on data s desired to be secret (secret data s) are the same, for example, distributed area 1:distributed area 2=1:1. In the symmetric-type secret sharing scheme of FIG. 7A, a size ratio between the secret data s and the share is, for example, secret data s:share 1=1:1.

In the threshold secret sharing scheme, the secret data s is saved by being distributed in a number of shares of n, and k (k≦n) of shares are collected and restored. Thus, original secret data s is obtained. Since the share is data converted into information which is not understood by a third party and is not decoded through calculation, it is possible to improve safety in view of information theory. The threshold secret sharing scheme illustrated in FIG. 7A is also referred to as a (k, n) threshold secret sharing scheme method having a threshold of k and a distribution number of n.

In addition to the (k, n) threshold secret sharing scheme method, various variations of secret sharing scheme processes (for example, (k, L, n) ramp-type secret sharing scheme having a threshold of k, a division number of L and a distribution number of n, secret sharing scheme having no threshold, polynomial secret sharing scheme, and fast secret sharing scheme using exclusive OR) are used as the secret sharing scheme process.

For example, by performing distribution management on the secret data s using the plurality of shares, it is possible to obtain redundancy. Thus, even when some of the saved shares are lost, it is possible to restore the secret data s. Accordingly, by using the secret sharing scheme process, it is possible to improve security in view of information theory, and it is possible to improve the reliability of camera system 5.

By using the secret sharing scheme process, it is not necessary to manage a key required for encoding. For example, when the ramp-type secret sharing scheme is used, it is possible to allow the data amount of the shares to be 1/L of the data amount of the secret data s.

In the secret sharing scheme process, since the plurality of shares is generated, the plurality of shares generated from the differential image is distributed and stored. For example, when the number of shares is n, a number of data items of n related to the differential image are output.

FIG. 7B shows an asymmetric-type secret sharing scheme process. The asymmetric type means that size ratios between the respective shares are different, for example, share 1:share 2=1:r. In the asymmetric-type secret sharing scheme of FIG. 7B, size ratios between the secret data s and the shares, for example, secret data s:share 1=1:1/(1+r), secret data s:share 2=1:r/(1+r). In the asymmetric type, the number of shares is typically 2.

For example, a size ratio (distribution ratio) between shares is 1:9 and the blurred image is added to the shares having a distribution ratio of 1. Thus, it is possible to reduce the data amount of image data received by PC 50 of main office 9 when the differential image is not required, and it is possible to rapidly grasp the outline of the image data.

In the following description, as a specific example of the secret sharing scheme process, it will be assumed that the threshold secret sharing scheme of n=3 and k=2 is mainly used.

Next, an operation example of camera system 5 will be described.

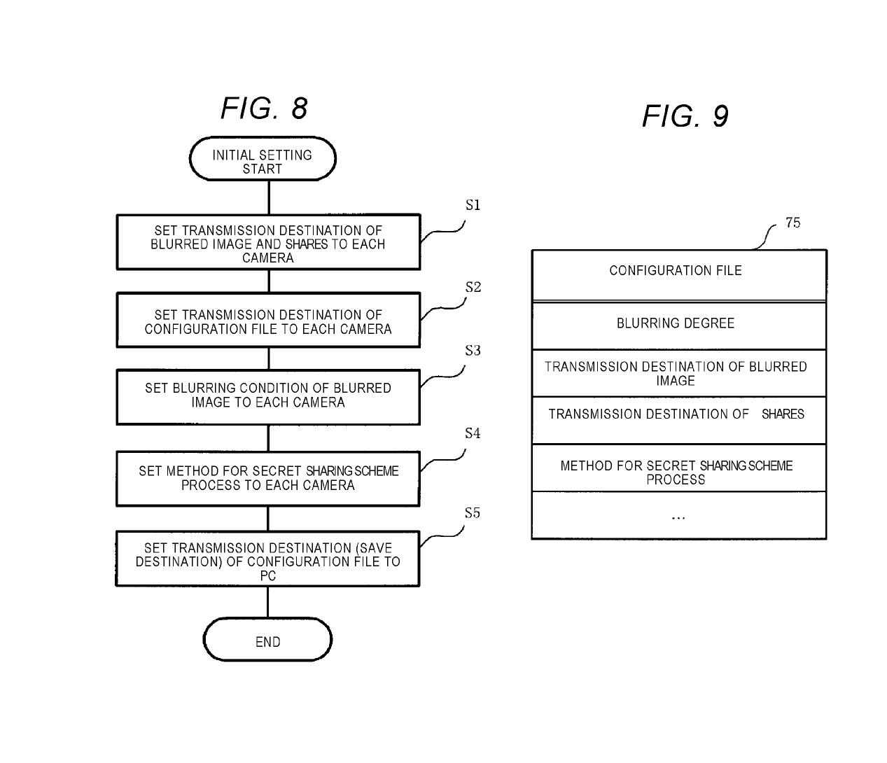

FIG. 8 is a flowchart showing an example of an initial setting procedure performed by a predetermined terminal. The initial setting refers to various settings for appropriately performing the secret sharing scheme process in camera system 5. For example, an administrator of camera system 5 performs an initial setting process of FIG. 8 by operating a terminal (not shown) connected to Internet 7 through an operation unit (not shown).

The terminal may be, for example, a portable terminal (smart phone), a tablet terminal, or a PC. The PC may be PC 50 provided in main office 9, or may be a PC provided in another area. The terminal may be camera 10. The terminal performs various settings by using, for example, a communication function.

The terminal includes, for example, a communication unit, an operation unit, a control unit, a display unit, and a storage unit. The terminal includes, for example, a central processing unit (CPU), a digital signal processor (DSP), a read only memory (ROM), and a read access memory (RAM). In the terminal, the CPU or the DSP realizes various functions of the terminal by executing programs stored in the ROM or the RAM.

In place of operating the terminal, setting information related to the secret sharing scheme process may be previously written in a storage medium (for example, a SD card), and this storage medium may be read in camera 10. Alternatively, an operator may directly set information with respect to camera 10 through an operation unit (not shown).

Firstly, the control unit of the terminal sets information related to the transmission destination of the shares of the differential image and the blurred image that are obtained from the image captured by camera 10 with respect to camera 10 (S1). For example, the information related to the transmission destination of the blurred image and the shares is registered in configuration file 75 retained in transmission destination storing unit 13.

The control unit of the terminal sets the transmission destination of configuration file 75 (for example, PC 50 and storage device 30) with respect to camera 10 (S2). For example, a safe place required for authentication is used as the transmission destination of this configuration file. The information related to the transmission destination of the configuration file is retained in, for example, transmission destination storing unit 13.

The control unit of the terminal sets a blurring condition (the degree of blurring) of the blurred image with respect to camera 10 (S3). For example, the setting value of the blurring condition is registered in configuration file 75 retained in transmission destination storing unit 13.

The control unit of the terminal sets a method for the secret sharing scheme process with respect to camera 10 (S4). For example, the method for the secret sharing scheme process includes a symmetric type and an asymmetric type. For example, in the case of the symmetric type, the method for the secret sharing scheme process includes setting values such as a distribution number, a threshold, and a ramp value. For example, in the case of the asymmetric type, the method for the secret sharing scheme process includes setting values such as a distribution ratio. For example, the method for the secret sharing scheme process includes setting information related to whether or not the original image or the differential image is used as a target to be subjected to the distribution process. The method for the secret sharing scheme process includes setting information related to whether to combine the shares with the blurred image. For example, the information related to the method for the secret sharing scheme process is registered in configuration file 75 retained in transmission destination storing unit 13.

When camera system 5 fixes the initial settings (settings in S1 to S3), it is necessary to initially perform these setting processes, and it is not necessary to perform these setting processes in the subsequent procedure.

Similarly to camera 10, the control unit of the terminal sets the information related to the transmission destination of configuration file 75 with respect to PC 50 (S5). The set information is stored in transmission destination storing unit 51. Thereafter, the initial setting operation is ended.

Through the initial setting operation of FIG. 8, even if the blurred image and the respective shares are saved in different storage destinations (for example, storage devices 30), the respective data items are associated. Thus, PC 50 can collect the respective data items as data to be restored. Since the information is registered in the respective items of configuration file 75, it is possible to perform the secret sharing scheme process desired by a user.

Since the transmission destination of the shares is designated through the operation unit, it is possible to improve the degrees of freedom of the save destination of the data.

FIG. 9 is a schematic diagram showing an example of the registration content of configuration file 75. The information registered in configuration file 75 is an example of the setting information related to the distribution process and the secret sharing scheme process.

For example, configuration file 75 includes the blurring degree, the transmission destination (save destination) of the blurred image, the transmission destination (save destination) of the shares, and the information related to the method for the secret sharing scheme process. For example, configuration file 75 is set by camera 10 at the time of the distribution process or the initial setting of the image data. Camera 10 transmits configuration file 75 to a predetermined save destination, and stores the configuration file. When it is necessary to refer to configuration file 75, PC 50 accesses the save destination of configuration file 75, and refers to configuration file 75.

For example, configuration file 75 is transmitted to a safe place (for example, a device including a secure region having temper resistance) designated in the initial setting and is saved. For example, configuration file 75 may be stored in PC 50 of main office 9, or may be stored in storage device 30 on a cloud (for example, public cloud 6). For example, configuration file 75 may be concealed through the encoding process or the secret sharing scheme process by the terminal. When the secret sharing scheme process is performed on configuration file 75, the number of transmission destinations of the shares of configuration file 75 becomes a number corresponding to the distribution number.

By using configuration file 75, even if the blurred image and the shares are saved in different storage destinations (for example, storage devices 30), the respective data items are associated. Thus, PC 50 can collect the respective data items as data to be restored. Since the information is registered in the respective items of configuration file 75, it is possible to perform the secret sharing scheme process desired by a user.

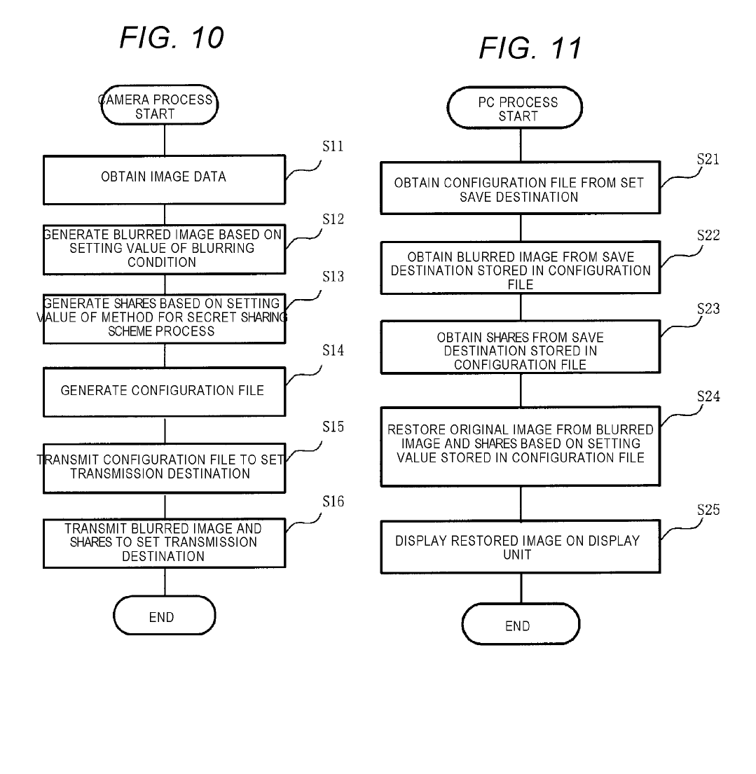

FIG. 10 is a flowchart showing an example of a processing procedure performed by camera 10.

Firstly, capturing unit 11 captures the image, and obtains the image data (original image) (S11). Image distributing unit 12 generates the blurred image from the original image based on the setting values of the blurring condition (S12). Image distributing unit 12 generates the shares of the differential image based on the setting values of the method for the secret sharing scheme process (S13). For example, these setting values are input through the operation unit of camera 10, and are set by image distributing unit 12.

A configuration file generating unit (not shown) of camera 10 generates configuration file 75 described above (S14). Configuration file 75 includes, for example, the setting values of S12 and S13. The configuration file generating unit is an example of a setting information generating unit.

Transmission unit 14 transmits configuration file 75 to the transmission destination (for example, PC 50 or storage device 30) of configuration file 75 set in S2 of FIG. 8 (S15).

Transmission unit 14 transmits the plurality of shares of the differential image and the blurred image by using the information related to the transmission destination stored in transmission destination storing unit 13 (S16). Thereafter, the transmission operation of camera 10 is ended.

According to the process shown in FIG. 10, since camera 10 generates the blurred image, it is possible to grasp the outline of the original image data by checking the blurred image. Accordingly, it is possible to ensure security, and it is possible to protect privacy. Since it is possible to restore the original image by another device (for example, PC 50) by generating the shares, it is possible to check the detail of the original image when necessary (for example, at the time of the occurrence of a crime). Accordingly, it is possible to improve security.

For example, the generation and transmission of the configuration file may be initially performed once, and may be omitted in the subsequent procedure. Alternatively, the generation and transmission of the configuration file may be performed whenever the image data is obtained.

FIG. 11 is a flowchart showing an example of a processing procedure performed by PC 50.

First, reception unit 52 obtains configuration file 75 from the save destination (transmission destination) of configuration file 75 stored in transmission destination storing unit 51 (S21). Reception unit 52 obtains the blurred image from the save destination registered in configuration file 75 (S22). Reception unit 52 obtains the shares of the differential image from the save destination registered in configuration file 75 (S23).

Image restoring unit 53 restores the original image by using the shares of the differential image and the blurred image based on the setting values (for example, the blurring degree and the method for the secret sharing scheme process) registered in configuration file 75 (S24). Display unit 54 displays the restored original image (S25). Subsequently, the reception operation of PC 50 is ended.

According to the process shown in FIG. 11, by checking the blurred image, it is possible to grasp the outline of the original image, and thus, it is possible to protect privacy. When the detailed information related to the original image is required (for example, at the time of the occurrence of a crime), the original image data is restored by obtaining the shares. Accordingly, it is possible to check the detail of the original image, and thus, it is possible to ensure security.

In camera system 5, all the shares are stored in storage device 30 of public cloud 6. Thus, in normal circumstances, main office 9 such as a monitoring center checks (views) the blurred image, and can grasp the outline of the original image. When necessary (for example, at the time of the occurrence of a crime), the remaining differential image is obtained, and it is possible to check the detail of the original image. Accordingly, it is possible to reduce the data amount of images to be obtained in normal circumstances.

For example, when camera 10 is a monitoring camera, several ordinary people who are not criminals are reflected in many cases. When the detail of the original image is allowed to be constantly grasped, there is a possibility that privacy will be invaded. In contrast, in camera system 5, since the outline of the original image is merely checked in normal circumstances, it is possible to appropriately protect privacy.

As stated above, it is possible to achieve both privacy and security, and thus, it is possible to allow the outline of the image data to be easily checked. Since the save destinations of the respective images can be arbitrarily designated at the time of the initial setting, it is possible to improve the degrees of freedom of the save destination of the image data.

For example, since the shares are respectively saved in storage devices 30 of public clouds 6 in the distributed manner, even if some of the shares are destroyed, or even if some of storage devices 30 are down, there is a possibility that the remaining shares will be used. For example, PC 50 can restore the original image by obtaining two shares of three shares. Accordingly, it is possible to strengthen the countermeasures (for example, countermeasures for server impairment, data loss at the time of disaster, and access securing) for business continuity planning (BCP).

Since camera 10 includes capturing unit 11, it is possible to capture the image, perform the distribution process, and transmit the blurred image and the shares in one device. Thus, it is possible to simplify the configuration within the base 3.

Since PC 50 obtains the plurality of shares and the blurred image and restores the data based on the setting information related to configuration file 75, it is possible to easily restore the original image. For example, since the blurring condition and the method for the secret sharing scheme process are registered as the setting values in configuration file 75, PC 50 can simply and appropriately perform the restoration process by referring to configuration file 75.

### Second Embodiment

In a second embodiment, a case where the shares are generated from the original image in place of the differential image will be described.

A camera system according to the second embodiment has the same configuration as that of camera system 5 according to the first embodiment. In the camera system according to the present embodiment, the same components as those of camera system 5 according to the first embodiment will be assigned the same reference numerals, and thus, the description thereof will be omitted or simplified. Although not shown, in the camera system according to the present embodiment, cameras 10A, storage devices 30 and PC 50A are connected via Internet 7.

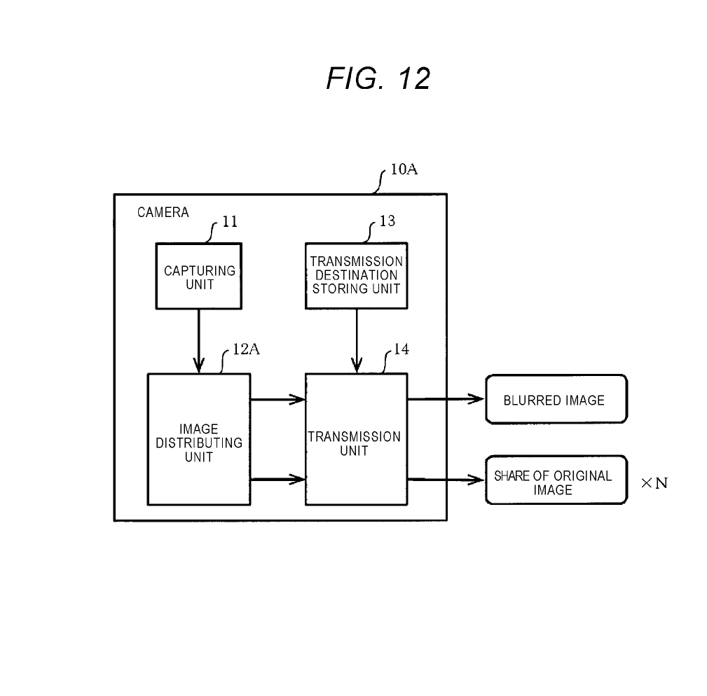

FIG. 12 is a block diagram showing a configuration example of camera 10A according to the second embodiment. Camera 10A has the same configuration as that of camera 10 except for having image distributing unit 12A.

Image distributing unit 12A generates a blurred image from the original image, but does not generate a differential image. Image distributing unit 12A performs a distribution process related to a predetermined secret sharing scheme method on the original image, and generates a plurality of shares of the original image. That is, the plurality of shares is generated for one original image.

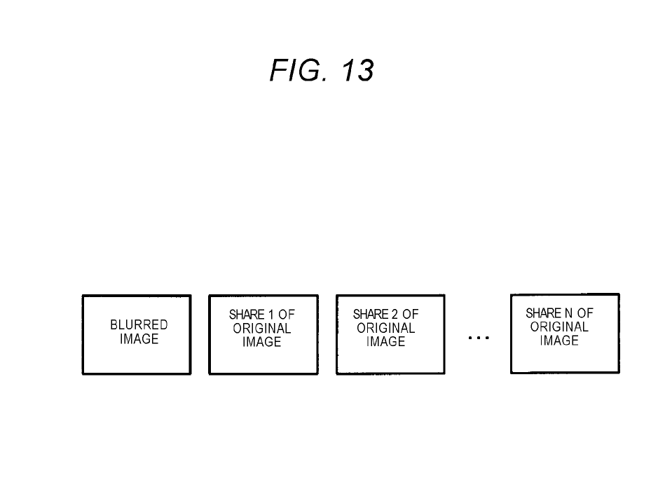

FIG. 13 is a schematic diagram showing an example of the format of shares. The blurred image from the image data captured by camera 10A and the plurality (a number of n) of shares of the original image are generated. In this case, the original image is restored by combining the plurality of shares of the original image. The blurred image is not necessary to restore the original image. Accordingly, PC 50 need not obtain the blurred image at the time of the restoration of the image, and thus, it is possible to reduce the amount of transmitted data items.

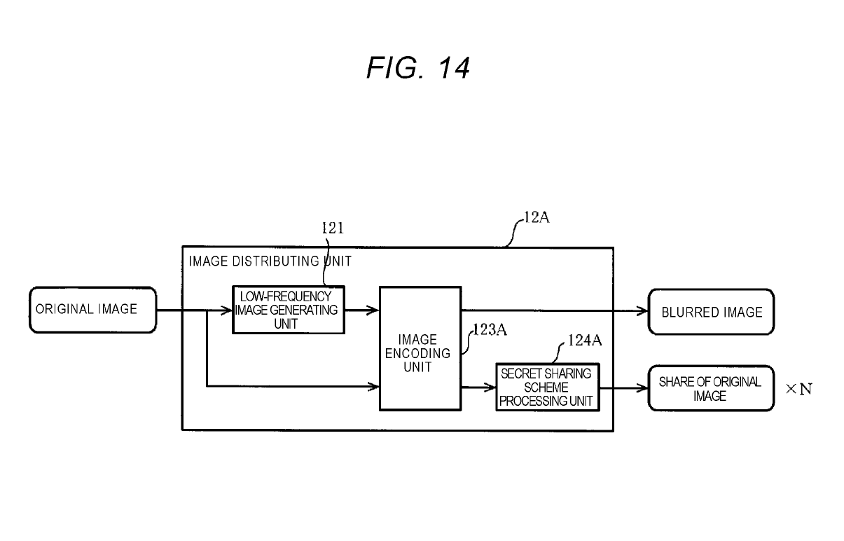

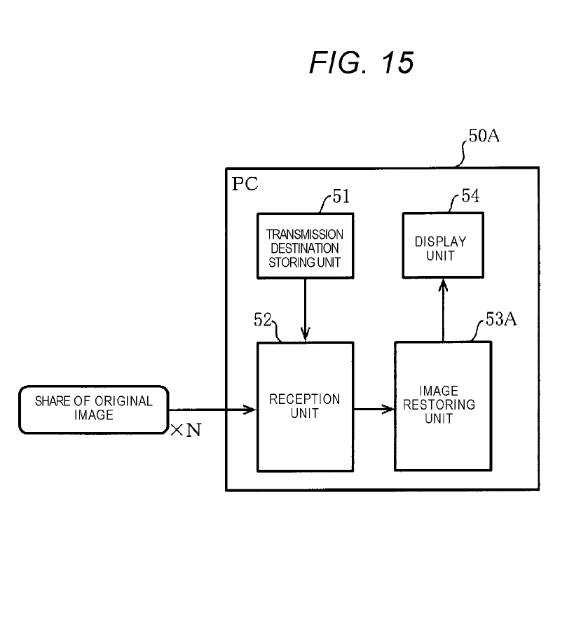

FIG. 14 is a block diagram showing a configuration example of image distributing unit 12A. Unlike image distributing unit 12, image distributing unit 12A does not include differential image generating unit 122, and includes image encoding unit 123A in place of image encoding unit 123, and secret sharing scheme processing unit 124A in place of secret sharing scheme processing unit 124.

Image encoding unit 123A encodes a low-frequency image from low-frequency image generating unit 121 and the original image. Secret sharing scheme processing unit 124A performs a distribution process on the encoded original image data, and obtains a plurality (N number) of shares of the encoded original image.

FIG. 15 is a block diagram showing a configuration example of PC 50A. PC 50A has the same configuration as that of PC 50 except for having image restoring unit 53A. Image restoring unit 53A performs a restoration process by using the plurality of shares of the original image, and obtains the original image.

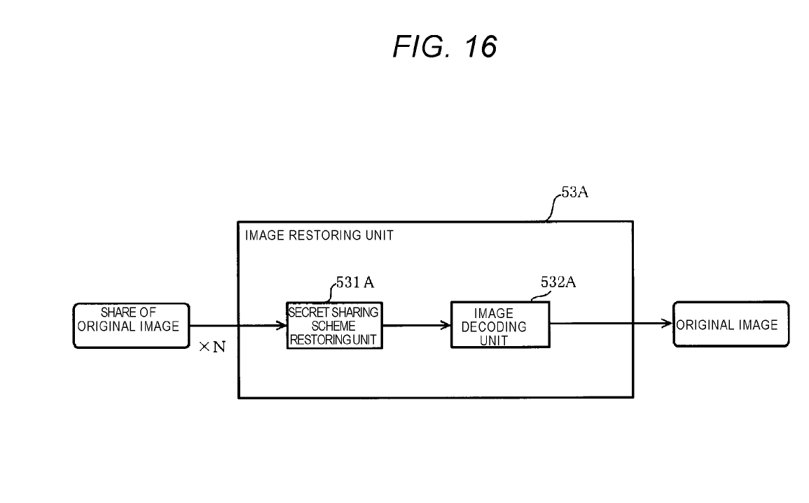

FIG. 16 is a block diagram showing a configuration example of image restoring unit 53A. Unlike image restoring unit 53, in image restoring unit 53A, secret sharing scheme restoring unit 531A and image decoding unit 532A are different, and image combining unit 533 is omitted.

Secret sharing scheme restoring unit 531A obtains the plurality of shares of the original image, performs the restoration process on the shares, and restores the encoded data of the original image. Image decoding unit 532A decodes the encoded data of the original image, and generates the data of the original image corresponding to one frame.

Next, an operation example of the camera system according to the present embodiment will be described.

Since the shares of the original image are communicated, the camera system according to the present embodiment performs the following operations which are different from the camera system according to the first embodiment.

In the process of camera 10A, in the flowchart shown in FIG. 10, the shares of the original image as the shares are generated in S13, and the generated data items are transmitted. Other procedures are the same as those of FIG. 10.

In the process of PC 50A, in the flowchart shown in FIG. 11, the procedure of obtaining the blurred image is omitted in S22, and the blurred image is not required to restore the original image in S24. Other procedures are the same as those FIG. 11.

In accordance with the camera system according to the second embodiment, the same effects as those of camera system 5 according to the first embodiment are obtained. It is not necessary to generate the differential image, and the blurred image is not required to restore the original image. Accordingly, it is possible to easily restore the original image by collecting the shares of the original image.

### Third Embodiment

In a third embodiment, a case where the blurred image is combined with the shares of the differential image and is transmitted will be described.

A camera system according to the third embodiment has the same configuration as that of camera system 5 according to the first embodiment.

In the camera system according to the present embodiment, the same components as those of camera system 5 according to the first embodiment will be assigned the same reference numerals, and thus, the description thereof will be omitted or simplified. Although not shown, in the camera system according to the present embodiment, cameras 10B, storage devices 30, and PC 50B are connected via Internet 7.

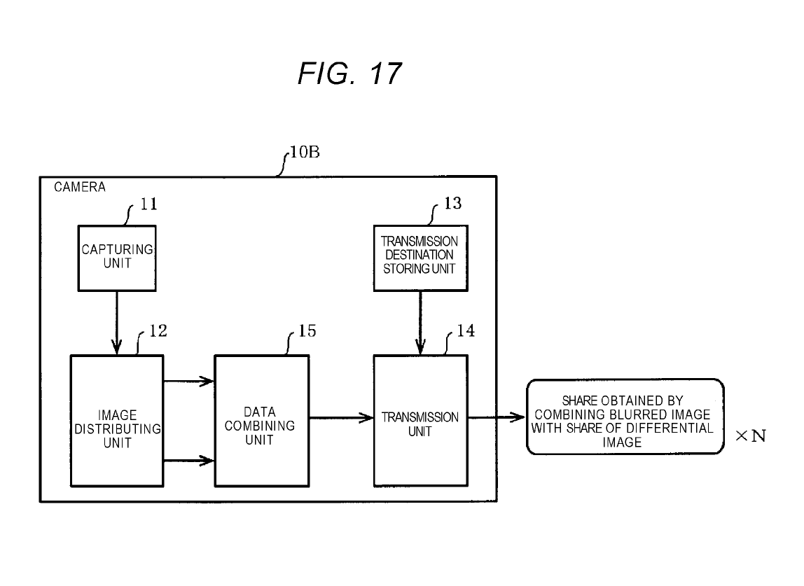

FIG. 17 is a block diagram showing a configuration example of camera 10B according to the third embodiment. Camera 10B has the same configuration as that of camera 10 except for having data combining unit 15.

Data combining unit 15 combines the blurred image with at least one share of the differential image. Transmission unit 14 transmits the shares obtained by combining the blurred image with the shares of the differential image. Transmission unit 14 may transmit the share of the differential image that is not combined with the blurred image. For example, a share to be combined with the blurred image is previously determined.

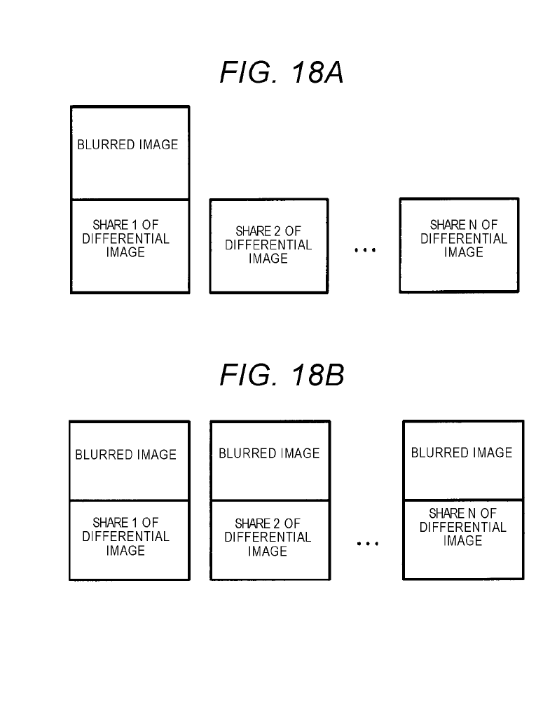

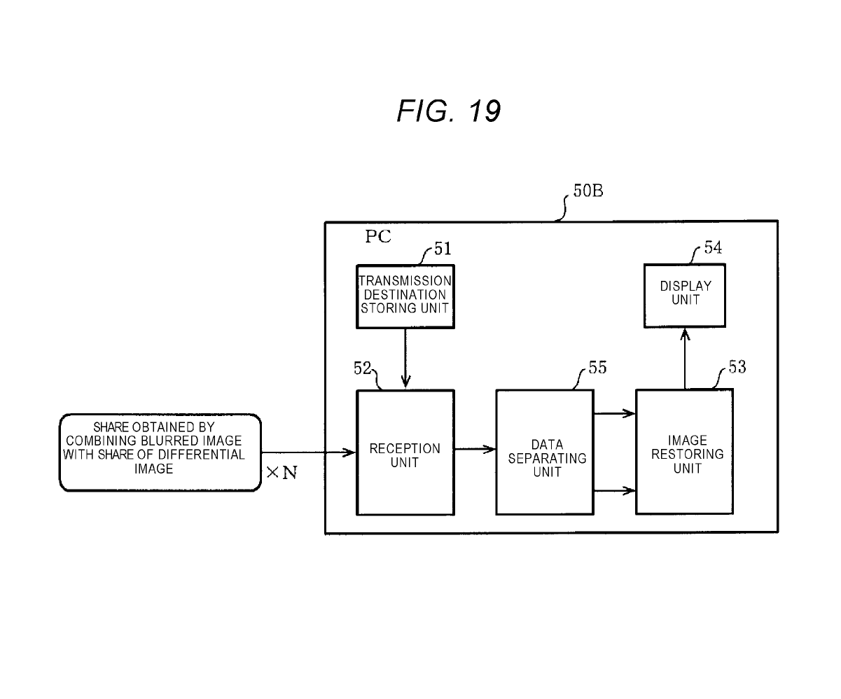

FIGS. 18A and 18B are schematic diagrams showing examples of the format of shares.

In FIG. 18A, a case where the blurred image is combined with one share (here, share 1) of the differential image and the blurred image is not combined with other shares of the differential image (here, shares 2, . . . , and N) will be described. Since the blurred image is initially combined with the shares obtained by PC 50, it is possible to grasp the outline of the original image by PC 50, and it is possible to reduce the total amount of saved data.

In FIG. 18B, a case where the blurred images are combined with all the shares of the differential image is illustrated. The respective blurred images combined with the respective shares are the same image. As shown in FIG. 18B, when the blurred images are combined with all the shares of the differential image, since the blurred images are transmitted to all the transmission destinations, it is possible to grasp the outline of the original image in all the transmission destinations, and it is possible to improve convenience. Since the blurred images are combined with at least two or more differential images, even if some of the blurred images are destroyed, it is possible to restore the original image by using the remaining blurred images.

FIG. 19 is a block diagram showing a configuration example of PC 50B. PC 50B has the same configuration as that of the first embodiment except for having data separating unit 55. Data separating unit 55 separates the blurred image and the shares of the differential image from the shares obtained by combining the blurred image with the shares of the differential image.

Next, an operation example of the camera system according to the present embodiment will be described.

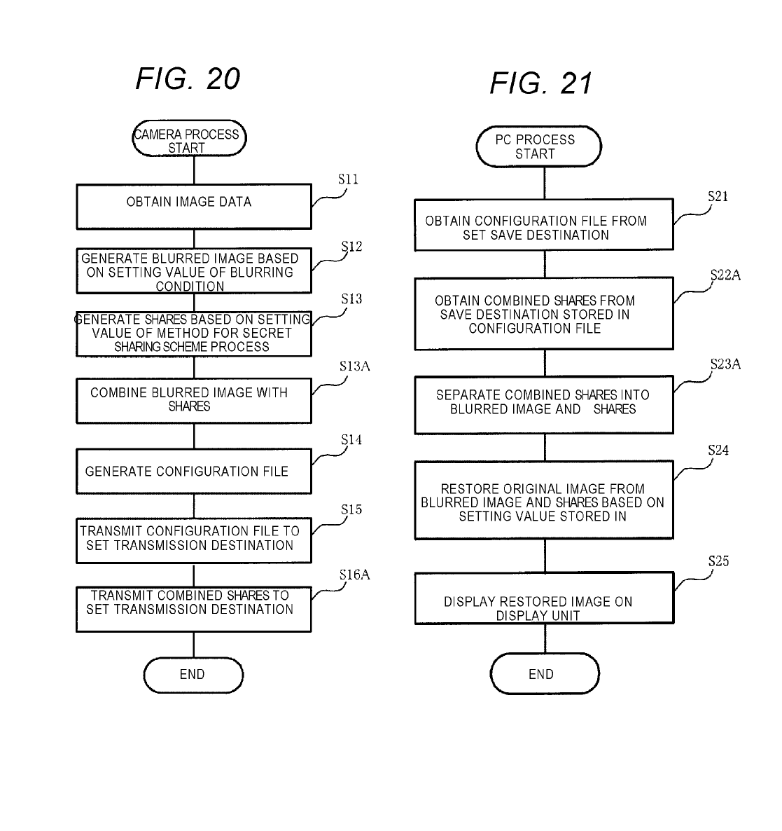

FIG. 20 is a flowchart showing an example of a processing procedure performed by camera 10B. In FIG. 20, the same processes as the processes of FIG. 10 will be assigned to the same step numbers, and the description thereof will be omitted or simplified.

In S12 and S13, after image distributing unit 12 generates the blurred image and the shares of the differential image, data combining unit 15 combines the blurred image with a predetermined share of the differential image (S13A). The blurred image is combined with at least one share of the differential image.

Transmission unit 14 transmits a plurality of shares obtained by combining the blurred image with the shares of the differential image (S16A). Transmission unit 14 may transmit the shares combined with the blurred image, or may transmit the shares that are not combined with the blurred image.

FIG. 21 is a flowchart showing an example of a processing procedure performed by PC 50B. In FIG. 21, the same processes as the processes of FIG. 11 will be assigned to the same step numbers, and the description thereof will be omitted or simplified.

Reception unit 52 obtains at least one share obtained by combining the blurred image with the share of the differential image (S22A) from the save destination (transmission destination) registered in configuration file 75. Reception unit 52 may receive the shares combined with the blurred image, or may receive the shares that are not combined with the blurred image.

Data separating unit 55 separates the combined shares into the blurred image and the shares of the differential image (S23A).

In S24, image restoring unit 53 performs a restoration process by using the separated blurred image and shares of the differential image based on the setting values registered in configuration file 75, and obtains the original image.

In accordance with the camera system according to the third embodiment, since the blurred image and the shares are combined, it is possible to check the blurred image in the transmission destination, and thus, it is possible to grasp the outline of the original image.

When the blurred image is combined with the shares having a small distribution ratio by using the asymmetric-type secret sharing scheme process, it is possible to grasp the outline of the original image by reducing the amount of transmitted data items in normal circumstances.

When the blurred image is combined with the shares having a large distribution ratio, it is possible to reduce the amount of transmitted data items at the time of the restoration when the restoration is required, and thus, it is possible to perform high-speed restoration.

Configuration file 75 according to the present embodiment may include the information related to the transmission destination of the shares combined with the blurred image or may include the information related to the transmission destination of the shares that are not combined with the blurred image, as the information related to the transmission destination.

### Fourth Embodiment

In a fourth embodiment, a case where the blurred image is combined with the shares of the original image and is communicated will be described.

A camera system according to the fourth embodiment has the same configuration as those of the camera systems according to the first to third embodiments. In the camera system according to the present embodiment, the same components as those of the camera systems according to the first to third embodiments will be assigned the same reference numerals, and thus, the description thereof will be omitted or simplified. Although not shown, in the camera system according to the present embodiment, cameras 10C, storage devices 30, and PC 50 are connected via Internet 7.

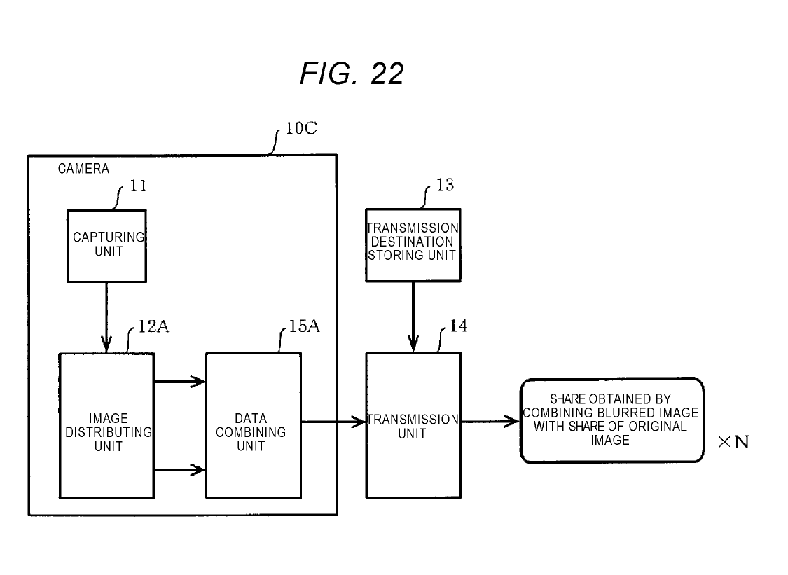

FIG. 22 is a block diagram showing a configuration example of camera 10C according to the fourth embodiment. Camera 10C has the same configuration as that of camera 10B in addition to image distributing unit 12A and data combining unit 15A.

Image distributing unit 12A generates the blurred image from the original image, and generates the shares of the original image. Data combining unit 15A combines the blurred image with at least one share of the original image. Transmission unit 14 transmits shares obtained by combining the blurred image and the shares of the original image. Transmission unit 14 may transmit the shares of the original image that are not combined with the blurred image. For example, a share to be combined with the blurred image is previously determined.

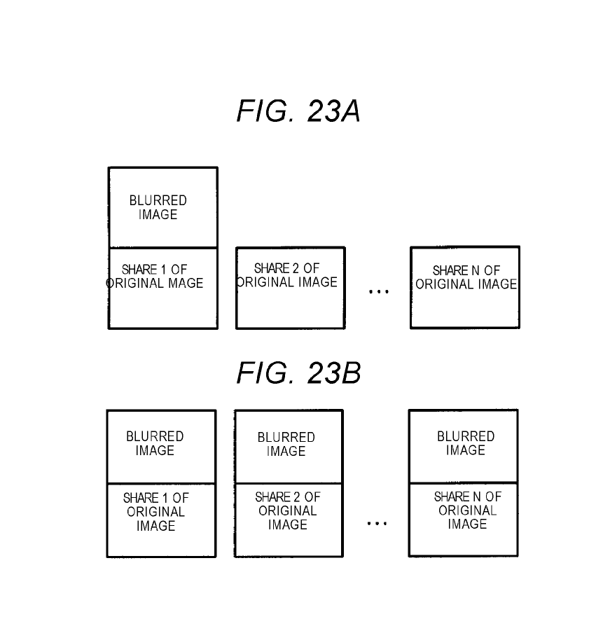

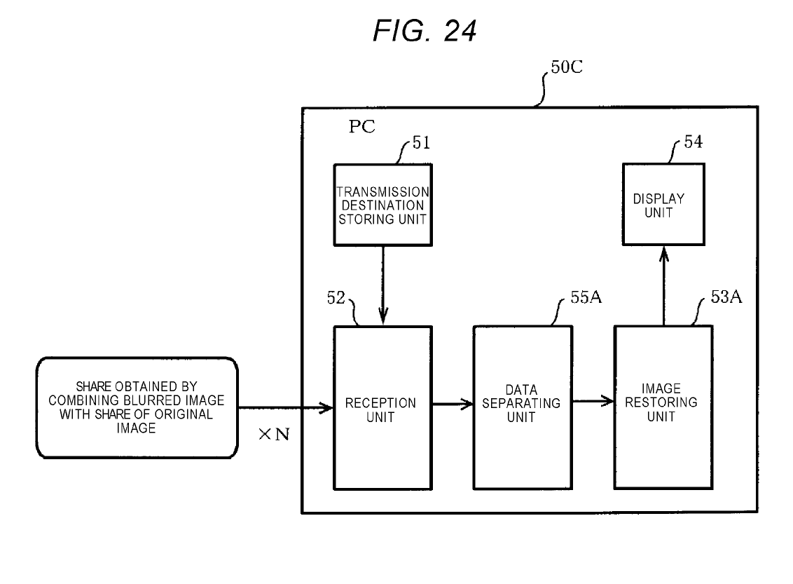

FIGS. 23A and 23B are schematic diagrams showing examples of the format of the shares.

In FIG. 23A, a case where the blurred image is combined with one share of the original image (here, a share 1) and the blurred image is not combined with other shares (here, share 2, . . . , and N) of the original image will be described. Since the blurred image is initially combined with the shares obtained by PC 50, it is possible to grasp the outline of the original image by PC 50, and it is possible to reduce the total amount of saved data.

In FIG. 23B, a case where the blurred images are combined with all the shares of the original image is illustrated. The respective blurred images combined with the respective shares are the same image. As shown in FIG. 23B, when the blurred images are combined with all the shares of the original image, since the blurred images are transmitted to all the transmission destinations, it is possible to grasp the outline of the original image in all the transmission destinations, and thus, it is possible to improve convenience.

FIG. 24 is a block diagram showing a configuration example of PC 50C. PC 50C has the same configuration as that of PC 50B in addition to having data separating unit 55A and image restoring unit 53A. Data separating unit 55A separates the shares obtained by combining the blurred image with the shares of the original image into the blurred image and the shares of the original image. Image restoring unit 53A performs a restoration process using the plurality of shares of the original image, and obtains the original image.

Next, an operation example of the camera system according to the present embodiment will be described.

Since the shares of the original image are transmitted, the camera system according to the present embodiment performs the following operations which are different from the camera system according to the third embodiment.

In the process of camera 10C, in the flowchart shown in FIG. 20, the shares obtained by combining the blurred image and the shares of the original image are generated and transmitted in S13A. Other procedures are the same as those of FIG. 20.

In the process of PC 50C, in the flowchart shown in FIG. 21, at least one share obtained by combining the blurred image with the shares of the original image is obtained in S22A, and the blurred image is not required to restore the original image in S24.

Other procedures are the same as those of FIG. 21.

In accordance with the camera system according to the fourth embodiment, the same effects as those of the camera system according to the third embodiment are obtained. Since the blurred image is combined with the shares, it is possible to grasp the outline of the original image by checking the blurred image in the transmission destination of the shares. Since the blurred image is not required to restore the original image, it is possible to easily restore the original image by collecting the shares of the original image.

Hereinafter, modification examples of the system configuration will be described. The following modification examples can be applied to all the camera systems according to the first to fourth embodiments.

### Modification Example 1

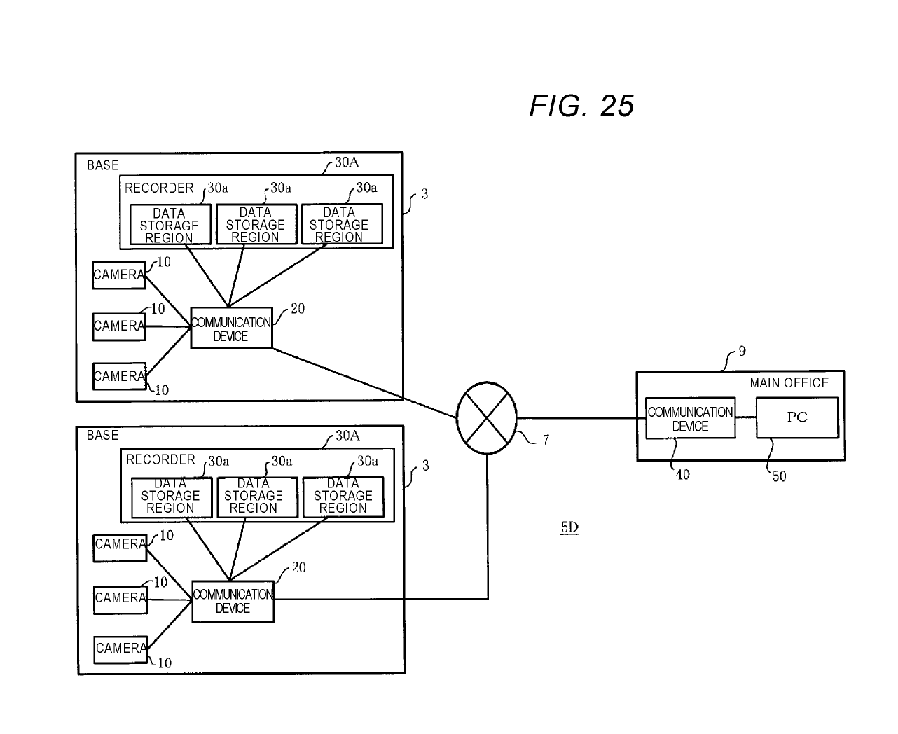

FIG. 25 is a schematic diagram showing the configuration of camera system 5D according to Modification Example 1. In camera system 5D, recorder 30A (an example of a storage device) is provided in base 3. The blurred image and all the shares are stored in data storage regions 30a of recorder 30A. In camera system 5D, the shares are not stored in public clouds 6 (see FIG. 1). For example, in base 3, cameras 10, communication device 20 and recorder 30A are connected via a narrow-area communication network such as a local area network (LAN). The information related to the transmission destination of the blurred image and the shares is included in configuration file 75. The narrow-area communication network includes at least one of a narrow-area wireless network and a narrow-area wired network.

PC 50 provided in main office 9 obtains the blurred image and the shares from recorder 30A connected via Internet 7, and restores the original image.

In camera system 5D, PC 50 typically obtains the blurred image from recorder 30A of base 3, and an administrator of PC 50 checks the obtained blurred image. When necessary (at the time of the occurrence of a crime), PC 50 obtains the blurred image and the shares of the differential image or the shares of the original image from recorder 30A of base 3, and restores the original image. The administrator of PC 50 checks the restored original image.

Thus, it is possible to prevent PC 50 from obtaining the image data in normal circumstances. By using recorder 30A within base 3 without using the cloud (for example, public cloud 6), it is possible to use the existing facility, and thus, it is possible to reduce costs required for camera system 5D.

PC 50 (or a tablet terminal equivalent to PC 50) may be provided in base 3, PC 50 of base 3 may restore the original image, and a user of base 3 may check the original image. In this case, security is ensured, and thus, it is possible to check the original image on the scene. Modification Example 1 obtains the same effects in both the symmetric-type secret sharing scheme process and the asymmetric-type secret sharing scheme process.

### Modification Example 2

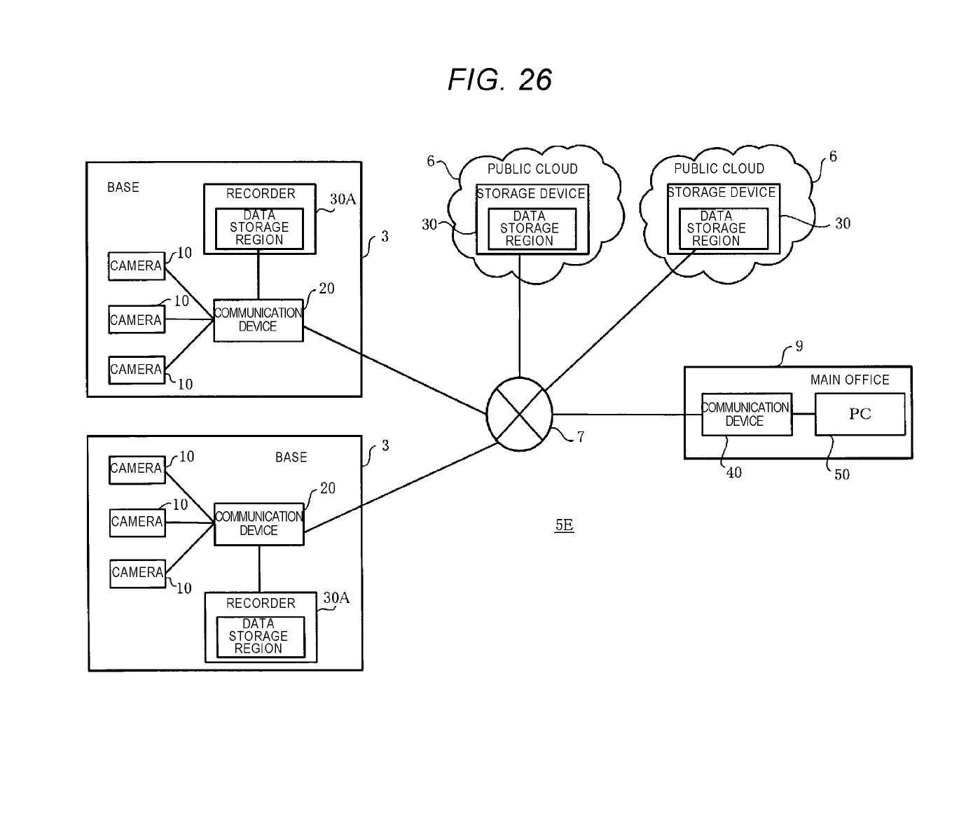

FIG. 26 is a schematic diagram showing the configuration of camera system 5E according to Modification Example 2. In camera system 5E, the shares are stored by storage device 30 of public cloud 6 and recorder 30A provided in base 3. For example, the blurred image is stored by storage device 30. The information related to the transmission destination of the blurred image and the shares is included in configuration file 75.

Accordingly, as described above, it is possible to reduce the amount of image data items transmitted by PC 50 in normal circumstances. When the symmetric-type secret sharing scheme process is performed and the plurality of shares is stored in public cloud 6, it is possible to strengthen the countermeasures for BCP. By using recorder 30A within base 3, it is possible to use the existing facility, and thus, it is possible to reduce costs required form camera system 5E.

For example, when the asymmetric-type secret sharing scheme process is performed, the blurred image is combined with the shares having a small distribution ratio, and thus, it is possible to reduce the size of communicated data in normal circumstances. Accordingly, it is possible to reduce communication costs.

### Modification Example 3

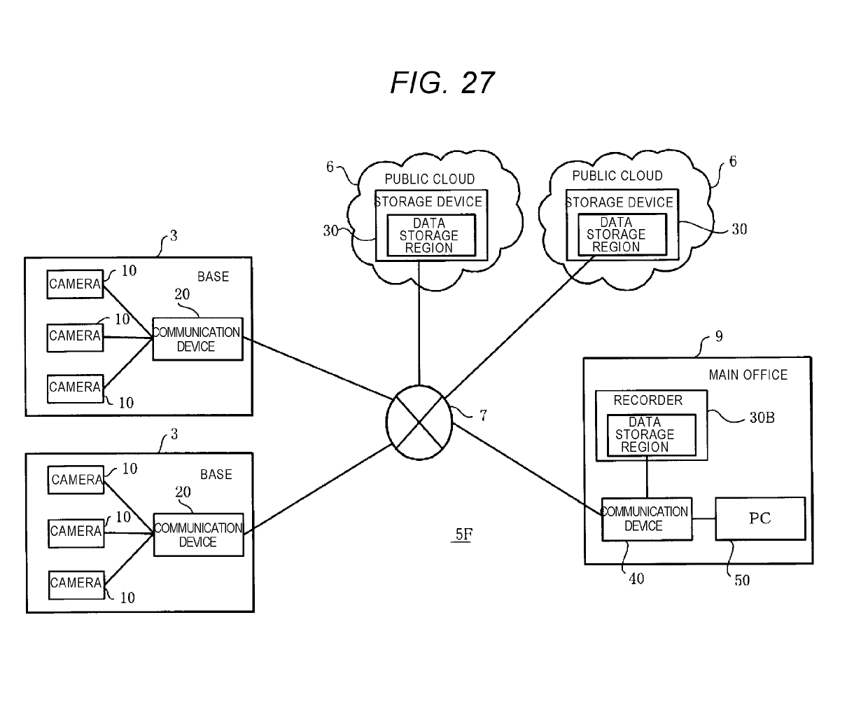

FIG. 27 is a schematic diagram showing the configuration of camera system 5F according to Modification Example 3. In camera system 5F, recorder 30B (an example of a storage device) is provided in main office 9, and the shares are stored by storage device 30 of public cloud 6 and recorder 30B provided in main office 9. For example, the blurred image is stored by recorder 30B. The information related to the transmission destination of the blurred image and the shares is included in configuration file 75.

Accordingly, as described above, it is possible to reduce the amount of image data items transmitted by PC 50 in normal circumstances. By using recorder 30B provided in main office 9, it is possible to reduce the amount of transmitted shares of the original image at the time of the restoration, and thus, it is possible to restore the original image by PC 50 at a high speed.

### Modification Example 4

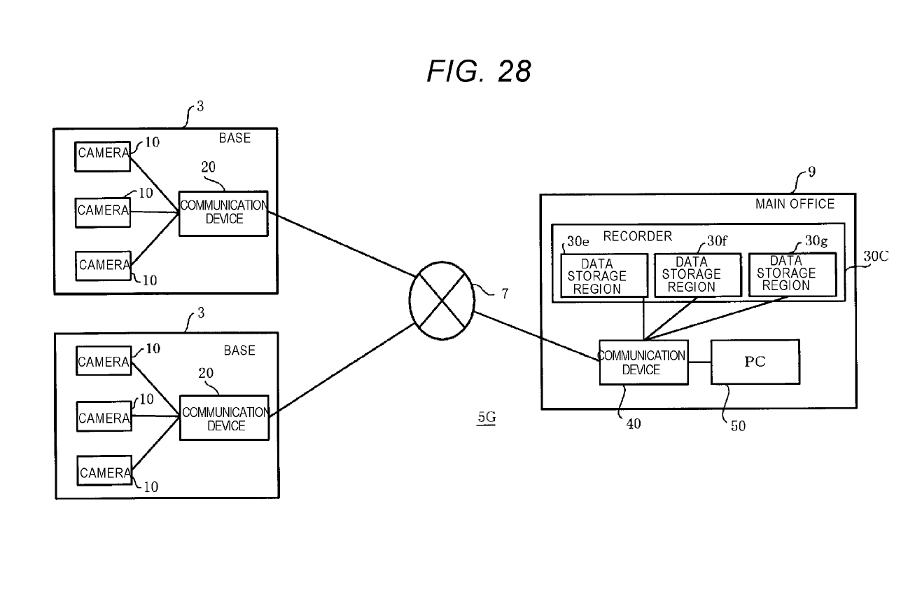

FIG. 28 is a schematic diagram showing the configuration of camera system 5G according to Modification Example 4. In camera system 5G, the blurred image and all the shares are stored in recorder 30C provided in main office 9. For example, multiple data storage regions 30e, 30f and 30g are allocated to recorder 30C, and the shares are respectively stored in these regions. For example, in main office 9, recorder 30C, communication device 40 and PC 50 are connected via a narrow-area communication network (for example, LAN). The information related to the transmission destination of the blurred image and the shares is included in configuration file 75.

According to camera system 5G, it is not necessary to provide recorder 30A in base 3, and thus, it is possible to simplify the system configuration of the base.

Since the blurred image and all the shares are stored in recorder 30C, it is possible to restore the original image by PC 50 at a high speed. Modification Example 4 obtains the same effects in both the symmetric-type secret sharing scheme process and the asymmetric-type secret sharing scheme process.

### Modification Example 5

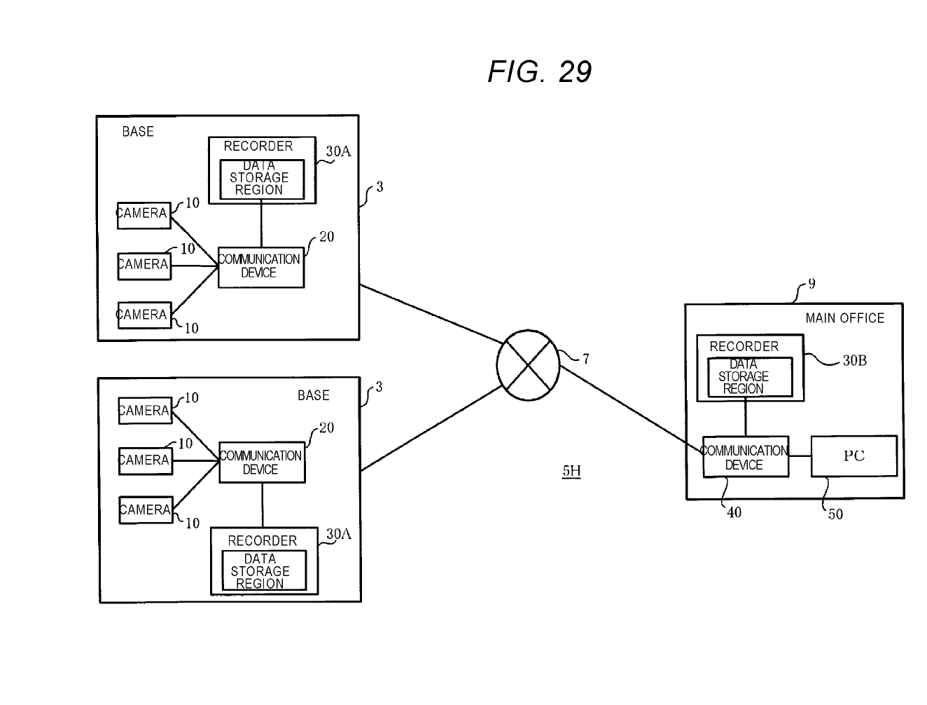

FIG. 29 is a schematic diagram showing the configuration of camera system 5H according to Modification Example 5. In camera system 5H, storage device 30 of public cloud 6 is not present, and the shares are stored in recorder 30A of base 3 and recorder 30B of main office 9. For example, the blurred image is stored by recorder 30B. The information related to the transmission destination of the blurred image and the shares is included in configuration file 75.

Accordingly, as described above, it is possible to reduce the amount of image data items transmitted by PC 50 in normal circumstances. Since PC 50 provided in main office 9 obtains only the shares other than the shares retained in recorder 30B from recorder 30A of base 3 at the time of the restoration of the original image, it is possible to reduce the amount of transmitted shares, and it is possible to restore the original image at a high speed.

### Modification Example 6

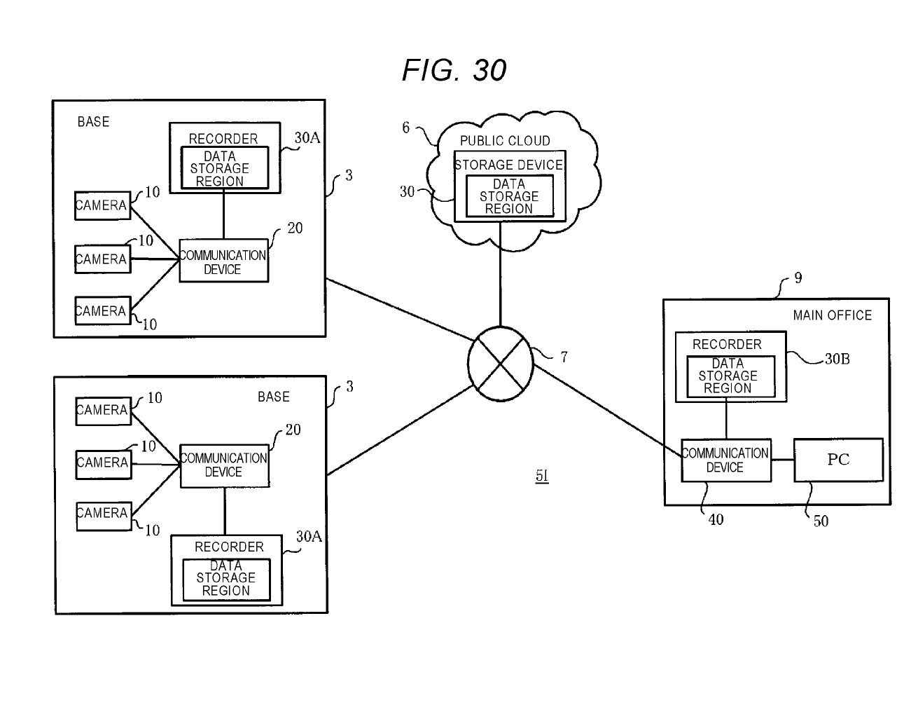

FIG. 30 is a diagram showing the configuration of camera system 5I according to Modification Example 6. In camera system 5I, storage device 30, recorder 30A, and recorder 30B are respectively provided in public cloud 6, base 3 and main office 9. The shares are respectively stored in storage device 30, recorder 30A and recorder 30B. For example, the blurred image is stored by recorder 30B. The information related to the transmission destination of the blurred image and the shares is included in configuration file 75.

Accordingly, as described above, it is possible to reduce the amount of image data items transmitted by PC 50 in normal circumstances. Since the save destinations of the shares are different, it is possible to strengthen the countermeasures for BCP. PC 50 provided in main office 9 obtains only the shares other than the shares retained in recorder 30B from recorder 30A of base 3 and storage device 30 of public cloud 6 at the time of the restoration of the original image.

For this reason, it is possible to reduce the amount of transmitted shares, and thus, it is possible to restore the original image at a high speed.

### Modification Example 7

It has been described in the first to fourth embodiments and Modification Examples 1 to 6 that camera 10 provided in base 3 generates the blurred image and the shares and transmits the generated image and data items. In Modification Example 7, it will be assumed that a PC is provided within base 3 and this PC generates the shares and transmits the generated data items. Modification Example 7 can be applied to the configuration of base 3 according to the first to fourth embodiments and Modification Examples 1 to 6.

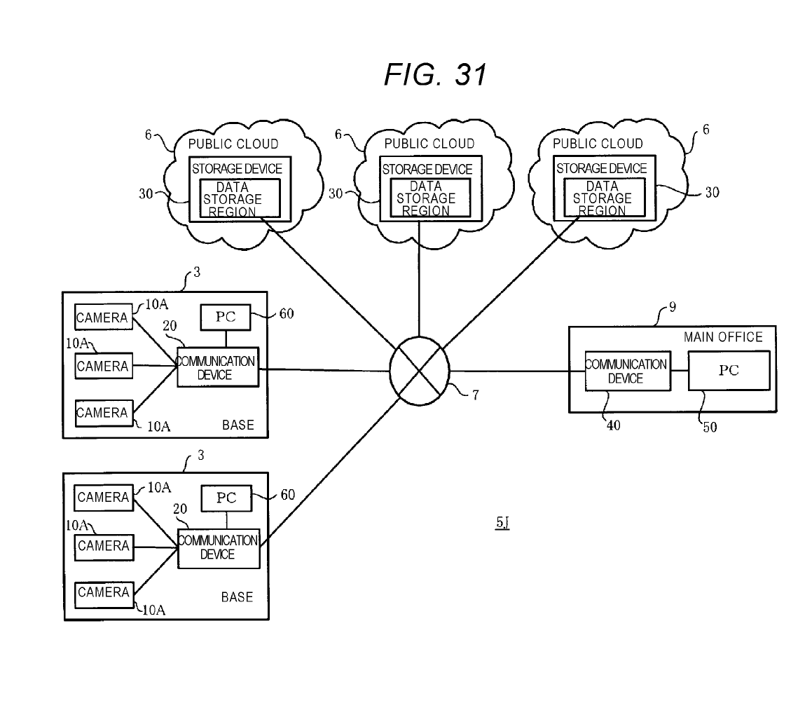

FIG. 31 is a schematic diagram showing the configuration of camera system 5J according to Modification Example 7. In camera system 5J, cameras 10A are provided in base 3 in place of cameras 10, and PC 60 is provided.

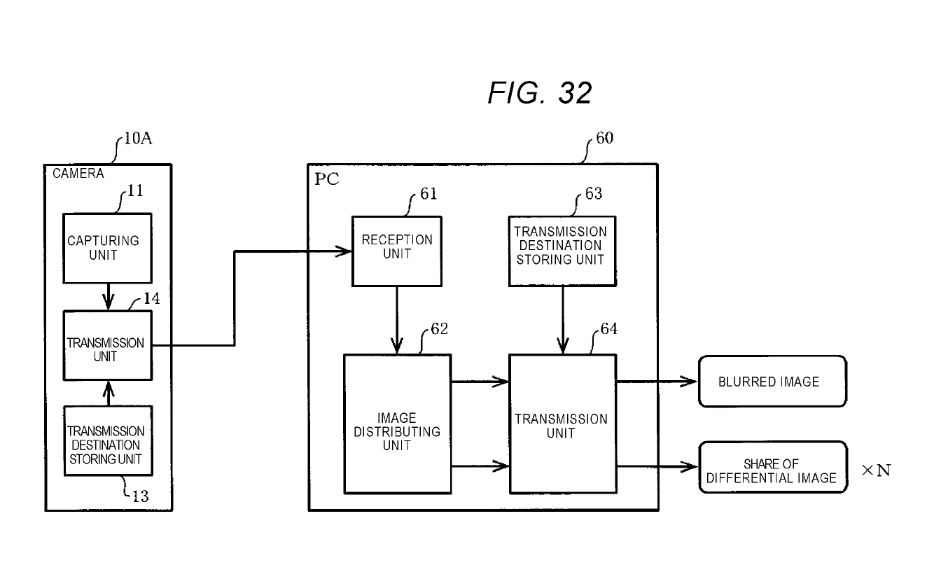

FIG. 32 is a block diagram showing configuration examples of camera 10A and PC 60. Unlike camera 10, camera 10A does not include image distributing unit 12 or 12A, and includes capturing unit 11, transmission destination storing unit 13, and transmission unit 14. For example, transmission destination storing unit 13 stores the information related to the transmission destination (here, PC 60) of the image data captured by capturing unit 11. Transmission unit 14 transmits the image data captured by capturing unit 11.

PC 60 includes reception unit 61, image distributing unit 62, transmission destination storing unit 63, and transmission unit 64. Reception unit 61 receives the image data from camera 10A.

Image distributing unit 62 has the same function as those of image distributing units 12 and 12A. That is, image distributing unit 62 generates the blurred image from, for example, the image data (original image) received by reception unit 61. Image distributing unit 62 may generate the differential image, and may generate shares of the differential image. Image distributing unit 62 may not generate the differential image, and may generate the shares of the original image.

Transmission destination storing unit 63 stores the same information as that of transmission destination storing unit 13. Transmission unit 64 refers to the information related to the transmission destination stored in transmission destination storing unit 63, and transmits the image generated by image distributing unit 62.

That is, PC 60 receives the image data (original image) captured by camera 10A, and generates the blurred image and the shares to transmit the generated image and data items. Thus, since camera 10A may not have the function (distribution processing function) of PC 60, it is possible to effectively utilize the existing camera, and thus, it is possible to reduce a process load of camera 10A.

Although various embodiments have been described with reference to the drawings, the present invention is not limited to the aforementioned examples. It is apparent to those skilled in the art that various changes or modifications are possible without departing from the scope described in the claims, and it should be understood that these changes or modifications are included in the technical scope of the present invention.

Although it has been described in the aforementioned embodiments that PC 50 provided in main office 9 performs the restoration process on the original image, a PC may be provided in base 3, and this PC may perform the restoration process on the original image.

In the aforementioned embodiments, when the shares are stored in recorder 30A of base 3, it has been considered that the shares are stored in recorder 30A of the same base 3 as base 3 where camera 10 that captures the original data is provided, but the shares may be stored in recorder 30A of different base 3.

The present invention is useful to an image processing system, an image processing device, and an image processing method that are capable of achieving both privacy and security, allowing the outline of image data to be easily checked, and improving the degrees of freedom of the save destination of the image data.

What is claimed is:

1. An image processing system in which a first image processing device, a second image processing device, and storage devices are connected via the Internet,
wherein the first image processing device includes
an image generating unit that performs a blurring process on captured first image data, and obtains second image data,
a distribution processing unit that performs a distribution process on the first image data or third image data based on the first image data, and obtains a plurality of shares, and
a first communication unit that transmits the second image data and the plurality of shares to at least one designated storage device,
wherein the storage device stores at least one of the shares and the second image data from the first image processing device, and
wherein the second image processing device includes
a second communication unit that receives the second image data and the plurality of shares from the at least one designated storage device, and
a restoration processing unit that restores the first image data based on at least the plurality of shares.

2. The image processing system of claim 1,
wherein at least one of the storage devices is connected to the first image processing device via a public communication network, and is disposed outside an area where the first image processing device is disposed.

3. The image processing system of claim 1,
wherein at least one of the storage devices is connected to the first image processing device via a narrow-area communication network, and is disposed inside an area where the first image processing device is disposed.

4. The image processing system of claim 1,
wherein at least one of the storage devices is connected to the second image processing device via a narrow-area communication network, and is disposed inside an area where the second image processing device is disposed.

5. The image processing system of claim 1,
wherein the image generating unit performs a distribution process on the first image data, and obtains a plurality of shares, and
the restoration processing unit restores the first image data based on the plurality of shares.

6. The image processing system of claim 1,
wherein the image generating unit generates a differential image between the first image data and the second image data, as the third image data,
the distribution processing unit performs a distribution process on the differential image, and obtains a plurality of shares, and
the restoration processing unit restores the first image data based on the second image data and the plurality of shares.

7. The image processing system of claim 1,
wherein the first communication unit transmits a plurality of shares including the shares combined with the second image data to at least one storage device,
the second communication unit obtains the plurality of shares from the at least one storage device, and
the restoration processing unit separates the second image data from the shares combined with the second image data, and restores the first image data based on at least the plurality of shares.

8. The image processing system of claim 1,
wherein the first image processing device includes a capturing unit that captures the first image data.

9. The image processing system of claim 1, further comprising:
a capturing device that captures the first image data,
wherein the capturing device transmits the first image data to the first image processing device, and
the first communication unit receives the first image data.

10. The image processing system of claim 1,
wherein the first image processing device includes a setting information generating unit that generates setting information related to the distribution process,
the first communication unit transmits the setting information,
the second communication unit receives the setting information, and obtains the second image data and the plurality of shares from the at least one storage device based on the setting information, and
the restoration processing unit restores the first image data based on the setting information.

11. The image processing system of claim 10,
wherein the setting information includes at least one of a storage destination of the second image data, a storage destination of the shares, a blurring condition for the blurring process, and information related to a distribution method for the distribution process.

12. An image processing device comprising:
an image generating unit that performs a blurring process on captured first image data, and obtains second image data;
a distribution processing unit that performs a distribution process on the first image data or third image data based on the first image data, and obtains a plurality of shares; and
a communication unit that transmits the second image data and the plurality of shares to at least one designated storage device.

13. An image processing device comprising:
a communication unit that receives second image data obtained by performing a blurring process on captured first image data and a plurality of shares from at least one designated storage device; and
a restoration processing unit that restores the first image data based on at least the plurality of shares.
wherein the shares are obtained by performing a distribution process on the first image data or third image data based on the first image data.

14. An image processing method in an image processing system in which a first image processing device, a second image processing device, and storage devices are connected via the internet, the method comprising:
causing the first image processing device to perform a blurring process on captured first image data, and to obtain second image data;
causing the first image processing device to perform a distribution process on the first image data or third image data based on the first image data, and to obtain a plurality of shares;
causing the first image processing device to transmit the second image data and the plurality of shares to at least one designated storage device;
causing the second image processing device to receive the second image data and the plurality of shares from the at least one designated storage device; and
causing the second image processing device to restore the first image data based on at least the plurality of shares.
